(19) United States
(12) Patent Application Publication
(10) Pub. No.: US 2025/0350547 A1
(43) Pub. Date: Nov. 13, 2025

(54) AUTO-RECOVERY FROM NEGATIVE PHASE JUMP EVENTS

(71) Applicant: ARRIS Enterprises LLC, Horsham, PA (US)

(72) Inventors: Anand Kumar GOENKA, Bengaluru (IN); Shashidhara CHANDRAPPA, Shivamogga (IN)

(73) Assignee: ARRIS Enterprises LLC, Horsham, PA (US)

(21) Appl. No.: 19/204,131

(22) Filed: May 9, 2025

Related U.S. Application Data
(60) Provisional application No. 63/644,818, filed on May 9, 2024.

(51) Int. Cl. H04L 43/0852; H04L 43/04

(52) U.S. Cl. CPC H04L 43/0858; H04L 43/04

(57) ABSTRACT

Device, systems and methods implemented in a distributed access architecture that allow a remote device to automatically recover from a phase jump event without resetting. A remote device may recover without resetting when a negative phase jump is detected.

### CROSS REFERENCE TO RELATED APPLICATIONS

The present application claims priority to U.S. Provisional Application No. 63/644,818 filed May 9, 2024, the content of which is incorporated herein by reference in its entirety.

### BACKGROUND

The subject matter of this application generally relates to the delivery of video content using distributed access architectures (DAA) of a hybrid CATV network, and more particularly to architectures that distribute the functions of the Cable Modem Termination System between a core and a remote device synchronized to the core, such as a Remote PHY device or Remote MACPHY device.

Although Cable Television (CATV) networks originally delivered content to subscribers over large distances using an exclusively RF transmission system, modern CATV transmission systems have replaced much of the RF transmission path with a more effective optical network, creating a hybrid transmission system where cable content terminates as RF signals over coaxial cables, but is transmitted over the bulk of the distance between the content provider and the subscriber using optical signals. Specifically, CATV networks include a head end at the content provider for receiving signals representing many channels of content, multiplexing them, and distributing them along a fiber-optic network to one or more nodes, each proximate a group of subscribers. The node then de-multiplexes the received optical signal and converts it to an RF signal so that it can be received by viewers. The system in a head end that provides the video channels to a subscriber typically comprises a plurality of EdgeQAM units operating on different frequency bands that are combined and multiplexed before being output onto the HFC network.

Historically, the head end also included a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern HFC CATV systems have combined the functionality of the CMTS with the video delivery system (EdgeQAM) in a single platform called the Converged Cable Access Platform (CCAP).

In these traditional HFC architectures, the video is modulated onto the RF network by a video Edge QAM (VEQ). A VEQ receives Internet-Protocol (IP) encapsulated Single & Multiple Program Transport Streams (SPTSs & MPTSs) from various sources (unicast/multicast) and, after removing any jitter from the network ingress stream, statically or dynamically maps these streams onto a QAM channel via one or more ports of the VEQ, remapping program identifiers (PIDs), while multiplexing as necessary individual SPTSs into a single M PTS. The VEQ may also perform local encryption of the video's elementary streams (ESs). To deliver an M PTS stream onto a QAM channel in accordance with ISO 13818-1 requires that the VEQ recover the ingress Program Clock Reference (PCR) values encoded within each SPTS and re-stamp it with the VEQ's internal 27 MHz clock so that all streams are delivered with the same time base.

As networks have expanded and head ends have therefore become increasingly congested with equipment, many content providers have recently used distributed architectures to spread the functionality of the CMTS/CCAP throughout the network. This distributed access architecture (DAA) keeps the cable data and video signals in digital format as long as possible, extending the digital signals beyond the CMTS/CCAP deep into the network before converting them to RF. It does so by replacing the analog links between the head end and the access network with a digital fiber (Ethernet/PON) connection.

One such distributed architecture is Remote PHY (R-PHY) distributed access architecture that relocates the physical layer (PHY) of a traditional CMTS or CCAP by pushing it to the network's fiber nodes. Thus, while the core in the CMTS/CCAP performs the higher layer processing, the R-PHY device in the node converts the downstream data sent by the core from digital to analog to be transmitted on radio frequency, and converts the upstream RF data sent by cable modems from analog to digital format to be transmitted optically to the core. Another distributed access architecture is Remote MAC PHY (R-MACPHY) where, not only is the physical layer of the traditional CMTS pushed into the network, but the functionality Media Access Control (MAC) layer, which is one of the two layers that constitute the data link layer of a transport stream, is also assigned to one or more nodes in the network in what is called a Remote MACPHY device (RMD).

Once the functionality of the CMTS/CCAP is divided between a core in the head end and various PHY or MACPHY devices throughout the network, however, protocols must be established to accurately preserve the timing of reconstructed video data that is communicated throughout the network. One typical arrangement to accurately preserve the timing of communicated video data is to ensure that the clocks of the various devices in the network are synchronized. FIG. 1, for example, shows an exemplary topology 10 that provides synchronization between a CCAP core 14 and an RPD 16, which is connected to one or more “consumer premises equipment (CPE) devices 18, though it should be noted that a similar topology may be used between a core and an RMD, for example. A timing grandmaster device 12 provides timing information to both the CCAP core 14 and the RPD 16. Specifically, the timing grandmaster 12 has a first master port 20a connected to a slave clock 22 in the CCAP core 14 and a second master port 20b connected to a slave clock 24 in the RPD 16, though alternatively the respective slave clocks of the CCAP core 14 and the RPD 16 may both be connected to a single master port in the timing grandmaster device 12. The CCAP core 14 may be connected to the timing grandmaster 12 through one or more switches 26 while the RPD 16 may be connected to the timing grandmaster 12 through one or more switches 28. Although FIG. 1 shows only one RPD 16 connected to the timing grandmaster 12, many such RPDs may be simultaneously connected to the grandmaster 12, with each RPD having a slave clock 24 receiving timing information from a port 20b in the grandmaster clock 12.

In DAA architectures, it is the remote video capable devices, such as an RMD and RPD, that include the VEQs that modulate a fully formed M PTS stream, sent by a core, onto the RF network. One benefit of this arrangement is that RMD/RPD devices are generally lower power than a traditional Video Edge QAM s located in a head end and need lower computational and memory resources. Similar to a VEQ located in a head end, a VEQ located in an RPD/RMD must map and modulate an IP-encapsulated, fully formed M PTS video stream it receives from a head end onto one or more QAM channels (one stream per channel), removing network jitter in the process. The difference relative to a VEQ in a head end, however, is that a VEQ in a remote device only receives a fully-encapsulated M PTS stream, hence does not need to multiplex together various SPTS content.

Also, in DAA architectures, however, because the functionality of the CMTS/CCAP is divided between a core in the head end and various PHY or MACPHY devices throughout the network, protocols must be established to accurately preserve the timing of reconstructed video data that is communicated throughout the network. Thus, even though a remote device only receives M PTS video data already synchronized together, the remote device still must account for any difference between the clock rate at which it receives data and the clock rate at which it outputs data. For example, the DAA remote device may not be synchronized to the same time base as that of the CCAP core (asynchronous operation), or even where the CCAP core and the remote device are synchronized to a common clock (synchronous operation) the CCAP core and the remote device may lose their timing lock.

While both the core 14 and the RPD 16 are locked with the timing grandmaster 12, no significant problems occur, but problems will occur when either the RPD 16 or the core 14 lose connection to the timing grandmaster 12. In that holdover period where one or both devices have no connection to the timing clock of the grandmaster 12, the unconnected devices will drift in frequency and phase from the timing grandmaster 12 and from the other device. The magnitude of that drift will depend on many factors, including the length of the holdover period, temperature variations, internal oscillator performance etc. For example, an RPD with a typical TCXO oscillator might drift 1 ms in phase even within one hour. Typically, an RPD's drift is worse than the core's drift as the core usually has a better oscillator and is in a temperature-controlled environment. If the period of holdover during which drift occurs is of a sufficient duration, video quality will degrade to an unacceptable level.

Alternative asynchronous architectures do not rely upon synchronization between a core and downstream devices like RPDs and RMDs, but these architectures involve more complicated processing and frequently result in dropped data packets.

What is desired therefore, are improved architectures and methods for accurately preserving timing information associated with video data transmitted in distributed access architectures.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary R-PHY system where both a CCAP core and its RPDs are timing slaves to an external grandmaster clock (GM).

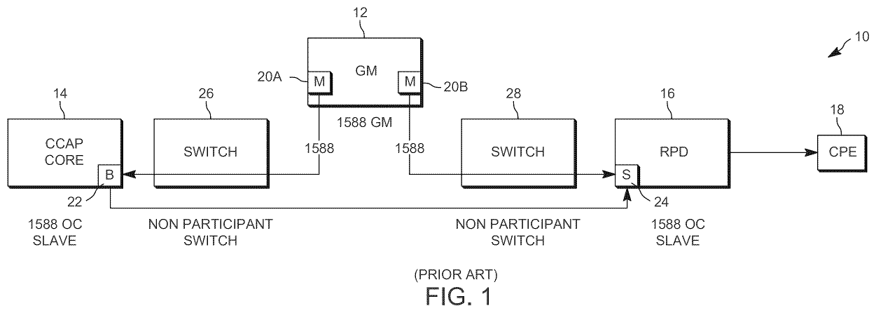

FIG. 2 shows an architecture where a video core transmits video data to an RPD in sync mode.

FIG. 3 shows an architecture where the video core of FIG. 2 transmits video data to the RPD of FIG. 2 in async mode.

FIG. 4 shows an exemplary architecture of a remote device in a distributed that processes video identically regardless of whether a video core transmits data to the remote device in sync or async mode.

FIG. 5 shows an exemplary method for processing video identically regardless of whether a video core transmits data to the remote device in sync or async mode.

FIGS. 6A and 6B show respective embodiments for self-recovery of a remote device after a negative phase jump event, without a reset.

### DETAILED DESCRIPTION

As noted previously, in Distributed Access Architectures (DAA) for delivery of video content, two modes of video handling may be used-synchronous mode and asynchronous mode. Typically, network devices have hardware capable of operating in either mode, with software that enables configuration by a video core of itself and connected downstream devices into either alternate one of these modes when setting up video channels. In sync (synchronous) mode, the RPD (or RMD) and its video core are synchronized in time to the same reference clock. In this sync mode the RPD is required merely to detect lost video packets using the Layer 2 Tunneling Protocol v.3 (L2TPv3) sequence number monitoring and insert MPEG null packets for each missing packet. This is a relatively simple implementation where there is no requirement for any additional modifications to the video stream.

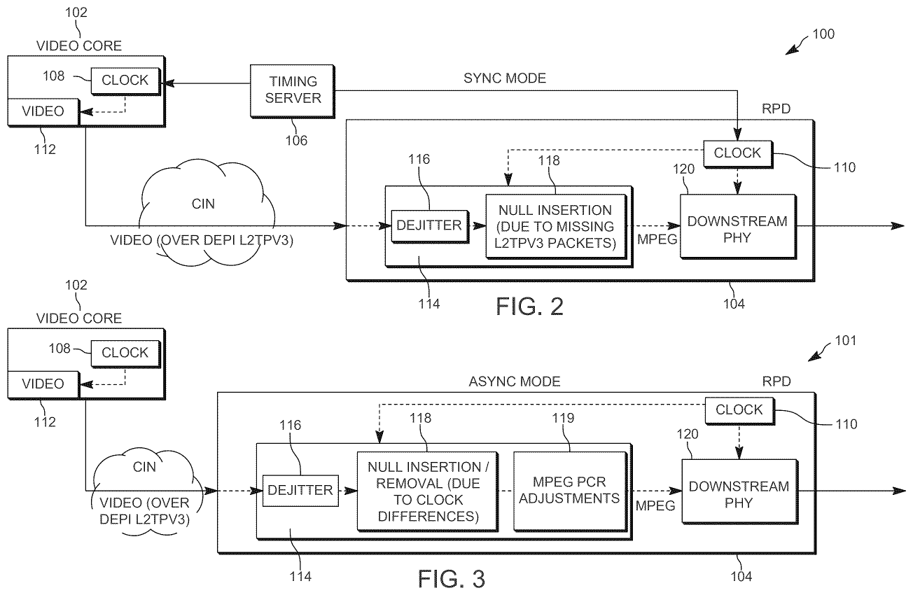

FIG. 2, for example, shows a system in a first configuration 100 where a video core 102 communicates with an RPD 104 in synchronous mode using a common grandmaster timing server 106. The timing server 106 maintains an identical timing lock (i.e. frequency and phase) with both the clock 108 in the video core 102 and the clock 110 in the RPD 104. The video core 102 has a video streamer 112 that forwards video data packet to the RPD 104 via a Downstream External PHY Interface (DEPI) using L2TPv3. The video packets sent from the video core 102 to the RPD 104 will typically include all information necessary to decode the packetized elementary video transport stream, such as Program Identifiers (PIDs), Program Clock Reference (PCR) data, etc.

The RPD 110 in turn, receives the video packets sent from the video core 108 in a dejitter buffer 116 of a processing device 114. The dejitter buffer 116 receives and outputs packet data at a rate that removes network jitter resulting from differing paths of received packet data, or other sources of varying network delay between the video core and the RPD. Because some packets sent by the video streamer 112 may be lost or misplaced during transport to the RPD 104, the packets output from the dejitter buffer 116 may preferably be forwarded to a module 118 that, in the case of sync mode, inserts null packets in the data stream to account for those lost packets, so as to maintain the proper timing rate of the transmitted video. The transport stream, with any necessary insertion of null packets is then forwarded to a PHY device 120, which may decode the packetized elementary stream into a sequence of decoded video frames for downstream delivery to end-users by outputting QAM-modulated data in a format expected by customer-premises equipment, like set-top boxes. Alternatively, the PHY device may simply forward the packetized data, without decoding, to e.g. a cable modem for decoding by a user device such as a computer, tablet, cell phone, etc.

Alternatively, the system just described may be configured to operate in an asynchronous (async) mode. In async mode, the RPD 104 and its video core 102 are not synchronized in time to the same reference clock. Instead, the RPD 104 is required to detect the difference between its own clock 110 and the clock 108 of the video core 102 and be able to either insert or remove MPEG packets as necessary to maintain expected MPEG bitrate, and also adjust the MPEG PCR values due to the removal/insertion of the MPEG packets.

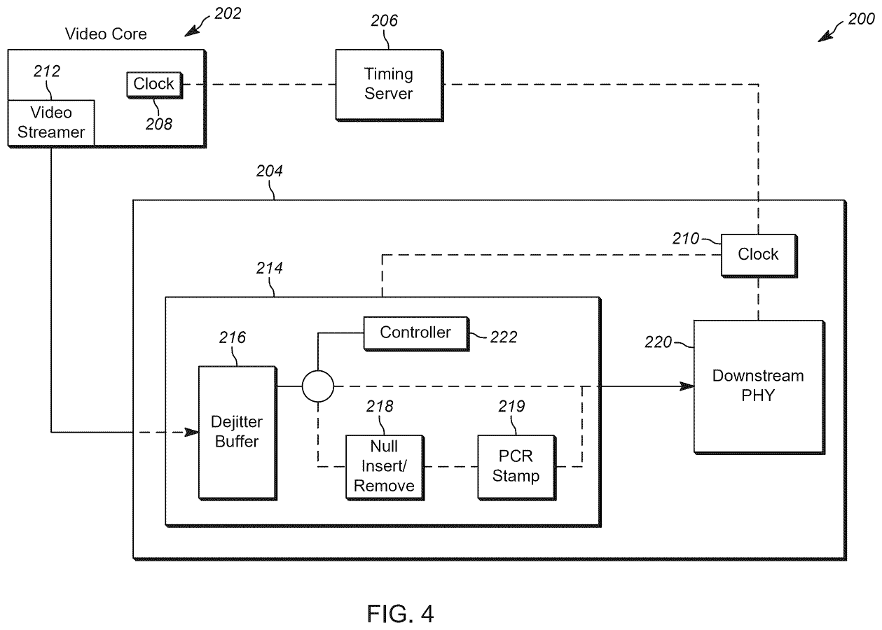

FIG. 3, for example, shows hardware configured to instead operate in async mode. In this configuration 101, the clock 108 of the video core 102 and the clock 110 of the RPD 104 are not synchronized and may therefore drift relative to each other. The video streamer 112 of the video core 102 forwards packets of the packetized video data elementary stream to the RPD 104, which again receives the data in dejitter buffer 116 to remove network jitter, as described previously. However, unlike the configuration of FIG. 2, the packets output from the dejitter buffer 116 are forwarded to the module 118 which both adds null packets when needed, and drops packets when needed, in order to maintain the proper constant bit rate of the data received from the dejitter buffer 116. Further, after packets are added/dropped as needed, a PCR module 119 re-stamps the data packets with updated PCRs due to the removal/insertion of MPEG packets before forwarding the re-stamped packets to the PHY device 120.

Although the systems 100 and 101 shown in FIGS. 2 and 3 are shown for illustrative purposes using an RPD 104 connected to a video core 102, those of ordinary skill in the art will appreciate that RMDs may also be connected to the video core 102 and have the same components shown with respect to the RPD 104 operate in the same manner as the RPD 104.

There are advantages and disadvantages to each of the synchronous and asynchronous modes of operation. With respect to the asynchronous mode, the main advantage is that there is no reliance on clock synchronization between the video core 112 and RPD 114; the RPD 114 will detect those clock differences and “fix” the MPEG output accordingly. The main disadvantages of asynchronous mode is that this mode is more complicated with respect to the video processing that occurs in the RPD 114 during synchronous mode, and that that in order to correct timing discrepancies, the RPD 114 needs to occasionally drop MPEG packets from the input stream. This adverse effect can be mitigated if the video core adds null packets to the stream so the RPD will have a null packet in hand when it needs to drop a packet, but this option adds unnecessary bandwidth to the data stream and/or adversely affects video quality, and frequently the video core does not add enough null packets to completely eliminate the necessity of dropping data-carrying packets.

For synchronous mode, the main advantage is the simplicity of video processing in the RPD where there is no need for the RPD to track changes between the input video stream and its internal clock, and no need for applying any MPEG modifications except of maintain a constant bitrate at its output by adding MPEG Null packets in case of a detected missing input packet. The main disadvantage of synchronous mode is the reliance on clock synchronization between the RPD and the video core. Although this assumption is usually valid as the video core and/or the RPD do not often lose connection to the grandmaster clock, there are circumstances when such connection is lost, and even when it is not, there may be cases where the clocks of the core and the RPD will not be adequately synchronized, due to differences in network delays in timing messages with the grandmaster clock, for example, or internal issues with wither the core or the RPD. In any of these instances, since the RPD in synchronous mode will not adjust any MPEG PCRs, the clock difference may cause an illegal MPEG streamout of the RPD, which could lead to observable degradation in video quality.

As noted previously, remote devices such as RPDs and RMDs that receive video data from a video core are typically configured to operate in either of sync mode or async mode, depending on which is preferred by the network operator. Also, as noted previously, the decision of whether to operate in sync mode or async mode involves sacrificing some benefits to achieve others. For example, operating in sync mode requires a sometimes unreliable timing connection to a common clock, and when this connection is lost and then regained, hardware devices need to be reset to regain proper synchronization, leading to network outages. Furthermore, even in sync mode, excessive network jitter may create the same issues that sync mode is supposed to avoid i.e., irregular receipt of the incoming video stream. Conversely, async mode adds processing complexity in an effort to avoid the foregoing issues, but this additional complexity may not be needed if the clocks of the core and the remote device are both very accurate.

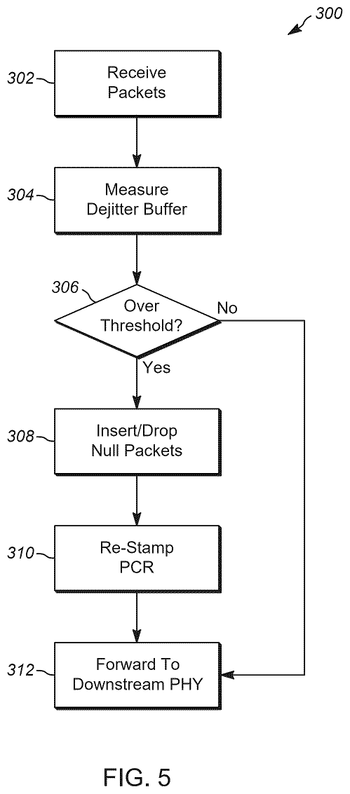

FIG. 4 shows an architecture 200 by which a remote device processes an incoming video stream identically, regardless of whether the core and the remote device are synchronized to a common clock. In this common architecture, the state of the dejitter buffer may be used to determine or assume whether the clock of the video core is sufficiently synchronized to that of the remote device so as to obviate the necessity of inserting null packets and restamping PCR data. Specifically, the remote device always includes a jitter buffer for handling the network jitter, both in case of synchronous and asynchronous video processing. When the clock frequency of the video core is higher as compared to the clock frequency of the remote device, this creates an overflow condition at the RPD, meaning that the dejitter buffer is receiving more packets than it releases. Conversely, when the clock frequency of the video core is lower than that of the remote device, this creates the underflow condition at the RPD i.e., the dejitter buffer releases packets at a higher rate than it receives. Both of these scenarios may result, not just from clock differences between the video core and the remote device, but also excessive jitter in the network between the video core and the remote device, or a combination of the two. Therefore, the present inventors realized changes in the fullness state of the dejitter buffer—regardless of whether caused by inadequate clock synchronization or network jitter—may be used as a basis for determining how incoming video packets should be processed.

Specifically, FIG. 4 shows a video core 202 with a clock 208 and video streamer connected to a remote device 204 with clock 210 in a distributed architecture. The remote device may be an RPD, and RMD, or any similar device such as a Remote Optical Line Terminal (OLT), Optical Network Unit (ONU), etc. The clock 208 of the video core 202 and the clock 210 of the remote device 204 may optionally be connected to a timing server 206 if operating in sync mode. Regardless of whether the clocks 208 and 210 are synchronized, however, the remote device 204 includes a processing device 214 configured to process incoming video packets from video streamer 212 identically. Video packets are received into a dejitter buffer 216 from video streamer 212 and controller 222 monitors changes to the fullness state of the dejitter buffer 216 and compares the magnitude of the change to one or more thresholds. For example, if the dejitter buffer 216 is filling at a rate greater than a first threshold, an overflow condition may be detected. Conversely, dejitter buffer is emptying at a rate greater than a second threshold, and underflow condition may be detected. In some embodiments, the first threshold may be the same as the second threshold while in other embodiments the first and second thresholds may be different.

If the comparison to the threshold(s) show that neither an overflow nor an underflow condition are detected, the controller 222 may cause packets that exit dejitter buffer 216 to be forwarded directly to the downstream PHY 220. Conversely, if either an overflow or underflow condition is detected, the controller 222 causes packets exiting the dejitter buffer 216 to be forwarded to module 218 that either drops null packets to correct for a detected overflow condition or inserts null packets to correct for a detected underflow condition. The packets are then forwarded to module 219 that re-stamps the PCR values in the packet headers before forwarding the packets to the downstream PHY 22.

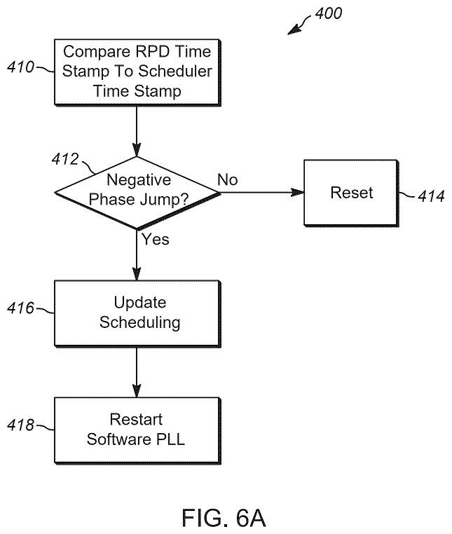

FIG. 5 shows an exemplary method that may be used by a remote device in a Distributed Access Architecture, such as the remote device 204 of FIG. 4. At step 302 the remote device may receive video packets into a dejitter buffer from a video core, and at step 304 the state of the dejitter buffer may be measured to quantify a rate of change in its fullness. At step 306, this measured rate of change may be compared to a selected one of one or more thresholds, so as to determine whether the dejitter buffer is instantaneously filling or emptying. If the threshold(s) are not exceeded, the packets may simply be forwarded to a downstream PHY. If one or more of the threshold(s) are exceeded, at step 308 packets (e.g., a null packet) may either be dropped, if the buffer is filling at a rate greater than the applicable threshold(s), or one or more null packets may be added if the buffer is emptying at a rate greater than the applicable threshold(s). Those of ordinary skill in the art may appreciate that additional thresholds may be added to determine a number of, or rate, at which packets need to be dropped or added. At step 310, when packets are either dropped or added, the PCR values in the packet headers of packets exiting the downstream PHY are re-stamped. After the PCR values of a packet are modified, it is then forwarded to the downstream PHY.

As previously indicated, the benefits of the common implementation shown and described in reference to FIGS. 4 and 5 are readily seen. In the case of synchronous video channels, a common implementation allows a remote device to perform NULL frames insertion/removal and PCR timestamp correction in network conditions of excessive jitter, which allows video channel quality to be maintained even in such condition. Also, there is no performance penalty for a synchronous video channel by having a common implementation for both synchronous and asynchronous video channels and the video core does not need to configure the remote device to either synchronous or asynchronous video processing.

As noted previously, protocols exist that ensure that distributed devices such as a video core and a remote device such as an RPD or RMD operate synchronously by ensuring that each device is locked to a common clock, e.g., a grandmaster clock. This may occur for several reasons, including a PTP grandmaster temporarily losing its GPS connection, a network re-convergence event due to router/switch crash or router switch link flap causing delay and Jitter for the PTP packets, etc. When one or both devices lose connection to a timing source, however, a number of problems may result, including degradation of video quality, due to the drift in the clocks of the respective devices.

Another issue occurs when a lost timing lock is restored, and synchronization is to be regained. At that time, there will usually be a phase discrepancy between the two clocks, meaning that the respective clocks are indicating different times. In that instance, a phase jump is typically performed to resynchronize the two clocks, and in that case the discrepancy between the timestamps of packets scheduled for future downstream transmission and the timestamps then being provided by the RPD (or RMD) clock by the scheduler causes the scheduler to stop scheduling packets. This necessitates a reset of the RPD (or RMD) to recover the RPD dataplane, which causes service interruption in the network.

The present inventors, however, realized that this reset is only necessary in the case of a positive phase jump i.e., where after regaining synchronization the clock of the RPD is ahead of the time at which the scheduler intends to transmit the next downstream packet; in this circumstance that time has passed and the remote device will need to be reset in order to reschedule packets. A negative phase jump however, occurs when the clock of the RPD, after regaining synchronization, is behind the time at which the scheduler intends to transmit the next downstream packet. Disclosed in this specification is a novel technique that avoids a reset during such negative phase jump events.

Specifically, an RPD may have an automatic detection and recovery mechanism for handling a negative phase jump event at RPD. As part of periodic scheduling, the RPD may preferably detect a negative phase jump event, which can be done by comparing the RPD clock current timestamp (driven from the synchronized clock) and the timestamp at which downstream channel's scheduler is expected to run. If the current timestamp is behind the downstream channel's scheduling timestamp, the negative phase jump event is considered detected.

Whenever the RPD detects a negative phase jump event, it may respond by restarting the scheduling of tasks/processes for respective downstream channels as per newly synchronized clock/timestamp. This may be accomplished because the transmissions of downstream packets are already scheduled for future times according to the RPD's resynchronized clock. Thus, the RPD may simply update the scheduling state (like time reference, sequence number etc.) needed for scheduling of respective downstream channels. Optionally, the RPD may restart a software Phase Locked Loop (PLL) if the scheduler uses a software PLL clock that is periodically synchronized to hardware clock. This will allow a remote device to automatically recover (self recover/heal) in case of negative phase jump events, without a reset.

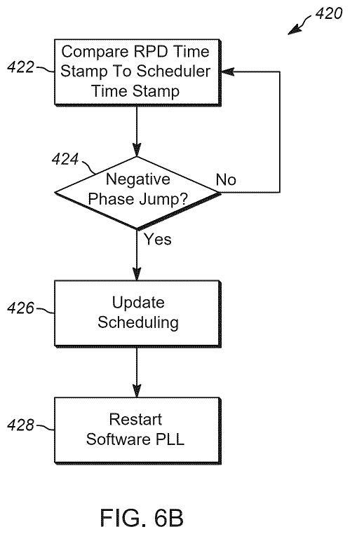

FIG. 6A shows such a procedure. Specifically, FIG. 6 shows a method 400 for automated self-recovery after a remote device recovers from a period of holdover, or otherwise resynchronizes to a core clock. At step 410, the timestamps from the clock of the remote device are compared with those of the scheduler. At step 412, based on this comparison, it is determined whether a negative phase jump has occurred. If not, at step 414 a reset is triggered. If so, at step 416 the scheduler updates the scheduling state e.g., time reference, sequence number etc. Optional step 418 resets a software PLL is one is used.

The method of FIG. 6A assumes that a period of holdover has occurred, and the clock of the remote device has recovered from that holdover. FIG. 6B shows an alternate procedure 420 that continuously monitors for the existence of a negative phase jump event during operation of the remote device. Specifically, at step 422 the timestamps from the clock of the remote device are compared with those of the scheduler. At step 424, based on this comparison, it is determined whether a negative phase jump has occurred. If not, the procedure returns to step 422. If so, at step 426 the scheduler updates the scheduling state e.g., time reference, sequence number etc. Optional step 428 resets a software PLL is one is used. In this procedure, the procedure constantly monitors for the existence of a negative phase jump. If there is no phase jump at all, the remote device will simply operate normally. If there is a positive phase jump, then the scheduler will be unable to schedule events since the scheduler is ahead of the RPD clock, and a reset will be triggered.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method implemented in a remote device of a Distributed Access Architecture and for recovering from a phase jump, the method comprising:
determining whether the phase jump is a negative phase jump; and
updating the scheduling of downstream video packets without resetting the remote device.

2. The method of claim 1 where the step of determining whether the phase jump is a negative phase jump includes comparing the timestamps provided by a clock of the remote device with timestamps associated with scheduled downstream packets.

3. The method of claim 1 where the step of updating the scheduling of downstream packets includes updating at least one of a timing reference or a sequence number.

4. The method of claim 1 where the step of updating the scheduling of downstream packets includes resetting a Phase Locked Loop (PLL).

5. The method of claim 4 where the PLL is a software PLL.

6. The method of claim 1 where the remote device resets if a negative phase jump is not detected.

7. The method of claim 1 where the remote device selectively resets based on whether there is a positive phase jump.

8. A remote device for use in a Distributed Access Architecture and for recovering from a phase jump, the remote device configured to:
determine whether the phase jump is a negative phase jump; and
update the scheduling of downstream video packets without resetting the remote device.

9. The remote device of claim 8 configured to determine whether the phase jump is a negative phase jump by comparing the timestamps provided by a clock of the remote device with timestamps associated with scheduled downstream packets.

10. The remote device of claim 8 configured to update the scheduling of downstream packets by updating at least one of a timing reference or a sequence number.

11. The remote device of claim 8 configured to update the scheduling of downstream packets by resetting a Phase Locked Loop (PLL).

12. The remote device of claim 11 of claim 4 where the PLL is a software PLL.

13. The remote device of claim 8 configured to reset if a negative phase jump is not detected.

14. The remote device of claim 8 configured to reset based on whether there is a positive phase jump.
